(19) United States
(12) Patent Application Publication
(10) Pub. No.: US 2019/0277640 A1
(43) Pub. Date: Sep. 12, 2019

(54) GNSS ELEVATION CORRECTION

(71) Applicant: GM GLOBAL TECHNOLOGY OPERATIONS LLC, Detroit, MI (US)

(72) Inventors: Praneeth Nelapati, Novi, MI (US); Curtis L. Hay, West Bloomfield, MI (US); Douglas A. Donaldson, Bloomfield Hills, MI (US); Steven R. Croyle, Bingham Farms, MI (US)

(21) Appl. No.: 15/913,295

(22) Filed: Mar. 6, 2018

(51) Int. Cl. G01C 21/32

(52) U.S. Cl. CPC G01C 21/32

(57) ABSTRACT

A system and method of providing elevation information to a vehicle, the method including: maintaining a map matching software system at a remote server facility, wherein the remote software system includes a geographical map database storing geographical maps; receiving an elevation correction request from the vehicle, wherein the elevation correction request includes current vehicle location information; in response to receiving the elevation correction request from the vehicle, extracting elevation information from the geographical maps based at least in part on the current vehicle location information; and after extracting the elevation information from the geographical maps, sending the extracted elevation information to the vehicle, wherein the extracted elevation information includes elevation information concerning an area at or near the vehicle or along a pathway of the vehicle.

### INTRODUCTION

The present invention relates to providing elevation information to a vehicle and/or correcting elevation information obtained by a vehicle.

Vehicles include hardware and software capable of obtaining and processing various information, including information that is obtained by vehicle system modules (VSMs). One such VSM is a global navigation satellite system (GNSS) receiver that can obtain or determine geographical coordinates of the vehicle. The geographical coordinates representing the vehicle's location can be used for carrying out autonomous or semi-autonomous operations of the vehicle and, in such cases, it is desirable to obtain accurate geographical coordinates. However, in certain locations, the reception of the GNSS receiver of the vehicle can be poor thereby causing the geographical coordinates to be less accurate.

### SUMMARY

According to one aspect of the invention, there is provided a method of providing elevation information to a vehicle, the method including: maintaining a map matching software system at a remote server facility, wherein the remote software system includes a geographical map database storing geographical maps; receiving an elevation correction request from the vehicle, wherein the elevation correction request includes current vehicle location information; in response to receiving the elevation correction request from the vehicle, extracting elevation information from the geographical maps based at least in part on the current vehicle location information; and after extracting the elevation information from the geographical maps, sending the extracted elevation information to the vehicle, wherein the extracted elevation information includes elevation information concerning an area at or near the vehicle or along a pathway of the vehicle.

According to various embodiments, this method may further include any one of the following features or any technically-feasible combination of some or all of these features:
the maintaining step further comprises periodically aggregating map data from third-party map sources;
the current vehicle location information comprises geographical information and the method further includes incorporating the received geographical information into the geographical map database along with the aggregated map data from the third-party map sources;
the vehicle is configured to generate and send the elevation correction request upon the occurrence of a triggering event associated with reduced geographical accuracy of geographical coordinates as determined onboard by the vehicle through reception of a plurality of global navigation satellite system (GNSS) signals from a constellation of GNSS satellites;
the vehicle is configured to periodically send the elevation correction request to the remote server facility;
the current vehicle location information includes a latitudinal coordinate of the vehicle, a longitudinal coordinate of the vehicle, and heading information of the vehicle;
sending a geographical map update to the vehicle, wherein the geographical map update includes updated geographical map information of an area surrounding the vehicle and/or new geographical map information of an area surrounding the vehicle of which the vehicle does not presently include geographical map information;
the method is embodied within one or more computer programs that are stored on a non-transitory computer-readable medium that comprises a part of one or more electronic servers that are located at the remote server facility and that are configured to execute the one or more computer programs;
the elevation information includes elevation data of an area corresponding to the current vehicle location information;
the extracting step further comprises using the current vehicle location information to query a geographical map database for the elevation information of the area corresponding to the current vehicle location information; and/or
the extracting step further comprises using the current vehicle location information in conjunction with geographical roadway map data to determine a location of the vehicle along a roadway and, thereafter, querying the geographical map database for the elevation information of the roadway at the location of the vehicle.

According to another aspect of the invention, there is provided a method of providing elevation information to a vehicle, the method including: receiving an elevation correction request from the vehicle, wherein the elevation correction request includes geographical information of the vehicle, and wherein the geographical information of the vehicle includes a latitudinal coordinate of the vehicle, a longitudinal coordinate of the vehicle, and heading information of the vehicle; in response to receiving the elevation correction request from the vehicle, obtaining elevation information from a geographical map database that is located at a remote server facility, wherein the elevation information is obtained based at least in part on the geographical information of the vehicle; and after obtaining the elevation information from the geographical map database, sending the obtained elevation information to the vehicle, wherein the obtained elevation information includes elevation information concerning an area in front of the vehicle and along a pathway of the vehicle.

According to various embodiments, this method may further include any one of the following features or any technically-feasible combination of some or all of these features:
the elevation correction request includes heading information of the vehicle and wherein the heading information is used to determine the area in front of the vehicle and along the pathway of the vehicle;
the obtaining step includes querying the geographical map database for geographical roadway map data and then using map matching software to determine a geographical coordinate location of the vehicle based on the geographical information of the vehicle as received in the elevation correction request and the geographical roadway map data; and/or
the map matching software is used to obtain the geographical coordinate location of the vehicle by mapping the geographical information of the vehicle to a roadway as indicated in the geographical roadway map data.

According to yet another aspect of the invention, there is provided a method of providing elevation information to a vehicle, the method including: determining to send an elevation correction request to a remote server facility; when it is determined to send the elevation correction request to the remote server facility, sending the elevation correction request to the remote server facility, wherein the elevation correction request includes geographical information of the vehicle, and wherein the geographical information of the vehicle includes a latitudinal coordinate of the vehicle, a longitudinal coordinate of the vehicle, and heading information of the vehicle; receiving an elevation correction response from the remote server facility, wherein the elevation information is based at least in part on the geographical information of the vehicle; and carrying out one or more vehicle operations using one or more vehicle system modules (VSMs) of the vehicle using the elevation information.

According to various embodiments, this system may further include any one of the following features or any technically-feasible combination of some or all of these features:
the geographical information of the vehicle is obtained using a global navigation satellite system (GNSS) receiver included in the vehicle;
the determining step includes recognizing a triggering event associated with reduced geographical accuracy of geographical coordinates as determined onboard by the vehicle through reception of a plurality of global navigation satellite system (GNSS) signals from a constellation of GNSS satellites;
the triggering event is recognized by determining that there are less than a predefined number of GNSS satellites of which GNSS signals are presently receivable by the GNSS receiver of the vehicle; and/or
the vehicle periodically sends the elevation correction request to the remote server facility and wherein the elevation correction response is received when the remote server facilities determines that any or all of the geographical information of the vehicle is inaccurate.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flowchart of an embodiment of a method of providing elevation information to a vehicle.

### DETAILED DESCRIPTION

The system and method described below enables a vehicle to receive elevation information of a location near the vehicle, including locations along a roadway and in the current or anticipated path of the vehicle. At least according to some embodiments, the method can include: maintaining a map matching software system at a remote server facility; receiving an elevation correction request from the vehicle; extracting elevation information from the geographical maps based at least in part on the current vehicle location information; and sending the extracted elevation information to the vehicle. The vehicle can use the elevation information to correct, adjust, and/or replace elevation information obtained from other mechanisms, such as a global navigation satellite system (GNSS) receiver that can be included on the vehicle. This elevation information can be obtained at the remote server facility through aggregating geographical map data from a variety of sources (including a fleet of vehicles and/or third-party geographical map providers). In this way, the vehicle can obtain more accurate elevation information to replace, supplement, or corroborate elevation information derived from the GNSS receiver.

In one embodiment, a remote server facility (or cloud-hosted server application) can be used to receive elevation correction requests from one or more vehicles and to, in response, extract and send elevation information to the one or more vehicles. The elevation correction request can be generated and sent periodically by the one or more vehicles, according to a schedule and/or according to pre-set triggers that, when triggered, operate to send the elevation correction request to the remote server facility. For example, when the vehicle is approaching an area of poor GNSS reception, the vehicle can anticipatorily send an elevation correction request with the vehicle's location and heading and, then, the vehicle can receive the elevation information from the remote server facility, which can be used in carrying out numerous vehicle functionality, including autonomous and/or semi-autonomous vehicle functionality. Additionally, the elevation information can be used to correct or adjust geographical coordinates that may be skewed due to poor GNSS reception, such as when GNSS signals are only received from a small number of GNSS satellites, which can correspond to less accurate geographical coordinates and elevation data.

In many embodiments, the remote server facility can aggregate geographical map data from a variety of sources, including various third party geographical map data providers and geographical feedback application services that are hosted by the remote server facility (or other facility co-owned or co-operated with the remote server facility). In this way, a geographical map database can be maintained at the remote server facility and used for providing accurate geographical information (including elevation information) to one or more vehicles. The remote server facility can implement map matching software, which can be used to aggregate the geographical and/or roadway data from the various sources, as well as correct or address inconsistencies between the data from the different sources. The one or more vehicles can also provide location and sensor information to the remote server facility, which can then incorporate the received location and sensor information into the aggregated geographical map data using, for example, the map matching software.

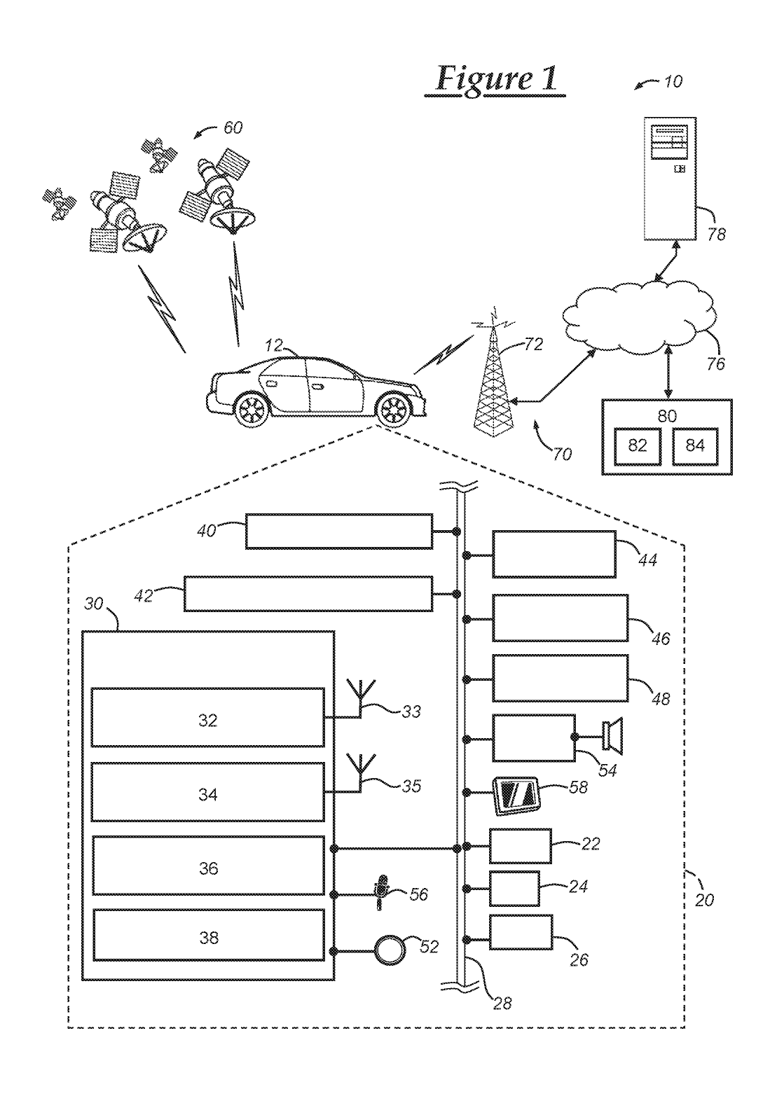

With reference to FIG. 1, there is shown an operating environment that comprises a communications system 10 and that can be used to implement the method disclosed herein. Communications system 10 generally includes a vehicle 12 with a wireless communications device 30 and VSMs 22-58, a constellation of global navigation satellite system (GNSS) satellites 60, one or more wireless carrier systems 70, a land communications network 76, a computer or server 78, and a remote server facility 80. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12 (e.g., wireless communications device 30)). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. Each such computer 78 can be used for one or more purposes, such as a geographical map provider that supplies geographical and/or topographical maps over the Internet. Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the vehicle 12, remote facility 80, or both. A computer 78 can also be used for providing Internet connectivity such as domain name system (DNS) services or as a network address server that uses dynamic host configuration protocol (DHCP) or other suitable protocol to assign an IP address to vehicle 12. In one embodiment, the computers 78 can be third-party geographical map providers that host geographical map information over the Internet (or other cloud-based network). The hosted geographical map information can be downloaded to the remote server facility 80 or vehicle 12 through interaction with an application programming interface (API) hosted by the third-party geographical map provider.

Remote server facility 80 may be designed to provide the vehicle electronics 20 with a number of different system back-end functions through use of one or more electronic servers and, in many cases, may be a vehicle backend services facility that provides vehicle-related backend functionality. The remote server facility 80 includes servers (vehicle backend services servers) 82 and databases 84, which may be stored on a plurality of memory devices. Also, remote facility 80 can include one or more switches, live advisors, an automated voice response system (VRS), all of which are known in the art. Remote facility 80 may include any or all of these various components and, in some embodiments, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and that include memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. This software (including the map matching software as discussed herein) may be stored in computer-readable memory such as any of the various types of RAM (random access memory) or ROM (read only memory). For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory computer-readable medium; these include different types of RAM (random access memory), ROM (read only memory), and magnetic or optical disc drives that stores some or all of the software needed to carry out the various external device functions discussed herein. One or more databases at the remote facility can store account information such as vehicle services subscriber authentication information, vehicle identifiers, vehicle transactional information, geographical coordinates of the vehicle, and other vehicle information. Also, a vehicle information database can be included that stores information pertaining to one or more vehicles. Additionally, in one embodiment, databases 84 can include geographical map information including geographical roadway map data that digitally represents geographical areas including roadways on the surface of earth. The geographical map data (including the geographical roadway map data) can also include or be based on topographical map information. Servers 82 can be used to provide this geographical roadway map data to a plurality of vehicles, including vehicle 12, so that the vehicles can correlate geographical coordinates (as obtained via GNSS receiver 22) with roadways and other features (e.g., points of interest, addresses, speed limits). In a particular embodiment, the vehicle 12 can send a geographical map request message that includes a geographical location or region of the vehicle and, in response to this message, the server 82 can query database 84 to obtain geographical map information corresponding to the geographical location or region of the vehicle. One such embodiment of a geographical map request message is an elevation correction request, which can be generated and sent by the vehicle to the remote facility 80. The elevation correction request can include geographical information of the vehicle or other vehicle location information, as discussed more below. The server 82 can then extract elevation information from the databases 84 and then send this information to the vehicle 12 (and various other vehicles) via land network 76 and/or cellular carrier system 70.

In one embodiment, the databases 84 can include a geographical map database that holds geographical map data, including topographical map data, geographical roadway map data, and/or elevation information. The geographical map database can be created or based on geographical map data obtained from a variety of sources, including third-party geographical map providers and geographical feedback application services. In one embodiment, the servers 82 can send requests to download geographical map data from a third-party geographical map provider, which may be hosted over the Internet (or on a “cloud”) using a computer 78. The geographical feedback application services can be an application that is hosted by the remote server facility (or other facility) that collects geographical and sensor information from a plurality of vehicles and then uses the collected information for forming and/or corroborating geographical map data, such as that which is received from the third-party geographical map providers.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a global navigation satellite system (GNSS) receiver 22, body control module or unit (BCM) 24, other vehicle system modules (VSMs) 26, a wireless communications device 30, wheel speed sensors 40, steering wheel angle sensor 42, yaw rate sensor 44, throttle position sensor 46, cameras 48, and vehicle-user interfaces 50-58. Some or all of the different vehicle electronics may be connected for communication with each other via one or more communication busses, such as bus 28. Communications bus 28 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, BCM 24, wireless communications device 30, wheel speed sensors 40, steering wheel angle sensor 42, yaw rate sensor 44, throttle position sensor 46, cameras 48, and vehicle-user interfaces 52-58, as will be described in detail below. The vehicle 12 can also include other VSMs 26 in the form of electronic hardware components that are located throughout the vehicle and, which may receive input from one or more sensors and use the sensed input to perform diagnostic, monitoring, control, reporting, and/or other functions. Each of the VSMs 26 is preferably connected by communications bus 28 to the other VSMs, as well as to the wireless communications device 30, and can be programmed to run vehicle system and subsystem diagnostic tests. One or more VSMs 26 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites. The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. GNSS receiver 22 may be used to receive GNSS signals and then to determine GNSS information, including geographical coordinates of the vehicle (e.g., latitudinal coordinates and longitudinal coordinates), heading information, and elevation information. The GNSS receiver 22 can also provide navigation and other position-related services to the vehicle operator using this GNSS information, as well as map information stored locally at the vehicle and updated periodically by the remote server facility 80, for example. Navigation information can be presented on the display 58 (or other display within the vehicle) or can be presented verbally such as is done when supplying turn-by-turn navigation. The navigation services can be provided using a dedicated in-vehicle navigation module (which can be part of GNSS receiver 22), or some or all navigation services can be done via the vehicle communications device (or other telematics-enabled device) installed in the vehicle, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 78, for other purposes, such as fleet management and/or for use in a car sharing service. Also, new or updated map data can be downloaded to the GNSS receiver 22 from the remote facility 80 via vehicle communications device 30.

In one embodiment, the GNSS receiver 22 may be a GPS receiver, which may receive GPS signals from a constellation of GPS satellites 96. And, in another embodiment, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22. Some of that processing may include making adjustments to the geographic coordinates received/determined by the receiver 22 before providing them to the remainder of the vehicle for use in navigation. This may be done, for example, to improve accuracy of the geographical coordinates for vehicles that are being operated in areas of poor or reduced GNSS reception (e.g., tunnels, congested urban areas). In one embodiment, the GNSS receiver can use elevation information obtained by the vehicle from the remote server facility 80 to improve the accuracy of the determined geographical coordinates and elevation data. This more accurate GNSS information can then be sent to other VSMs of the vehicle 12.

Body control module (BCM) 24 is shown in the exemplary embodiment of FIG. 1 as being electrically coupled to communication bus 28. In some embodiments, the BCM 24 may be integrated with or part of a center stack module (CSM) and/or integrated with wireless communications device 30. Or, the BCM may be a separate device that is connected to other VSMs via bus 28. BCM 24 can include a processor and/or memory, which can be similar to processor 36 and memory 38 of wireless communications device 30, as discussed below. BCM 24 may communicate with wireless device 30 and/or one or more vehicle system modules, such as an engine control unit (ECU) (not shown), wheel speed sensor 40, steering wheel angle sensor 42, yaw rate sensor 44, throttle position sensor 46, cameras 48, audio system 54, or other VSMs 26. BCM 24 may include a processor and memory accessible by the processor. Suitable memory may include non-transitory computer-readable memory that includes various forms of non-volatile RAM and ROM. Software stored in the memory and executable by the processor enables the BCM to direct one or more vehicle operations including, for example, controlling central locking, air conditioning, power mirrors, controlling the vehicle primary mover (e.g., engine, primary propulsion system), and/or controlling various other vehicle modules.

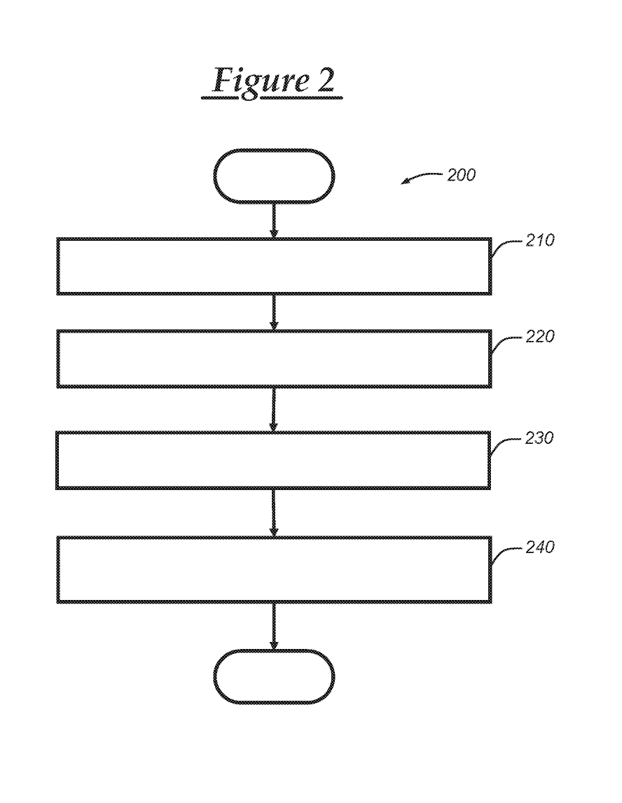

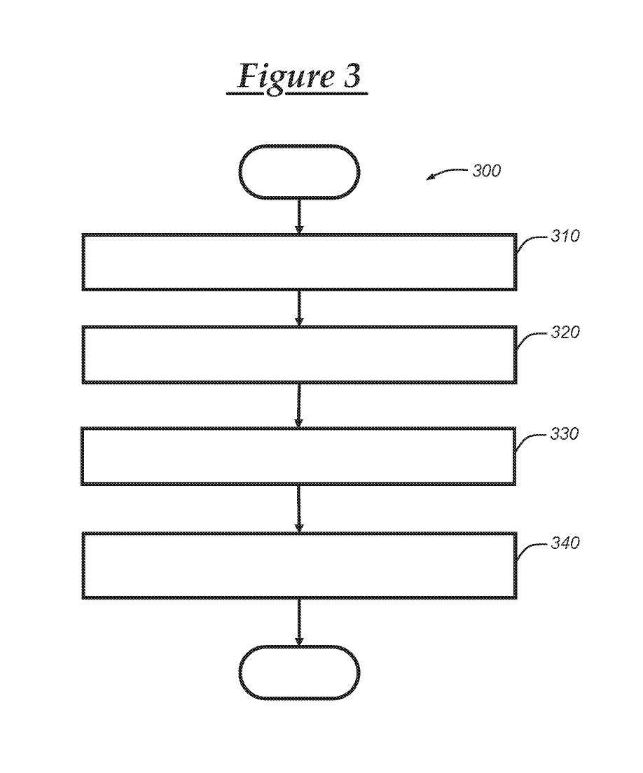

For example, the BCM 24 can send signals to other VSMs, such as a request for sensor information. And, the BCM 24 may receive data from VSMs, including wheel speed readings or sensor data from wheel speed sensor 40, steering wheel angle readings or sensor data from steering wheel angle sensor 42, yaw rate readings or sensor data from yaw rate sensor 44, throttle position readings or sensor data from throttle position sensor 46, and camera data from cameras 48. Any of this sensor information can be used by a vehicle navigation system to determine a geographical location of the vehicle, such as through use of dead reckoning techniques. And, in some embodiments, the vehicle can use geographical coordinates derived from the GNSS receiver 22 to calibrate a starting point for use with the dead reckoning techniques, as carried out by the vehicle via use of one or more sensors, such as sensors 40-48. Moreover, pursuant to at least one embodiment of the method discussed herein, the calibration point for the dead reckoning techniques can be derived from GNSS information obtained using the GNSS receiver 22 as updated through use of method 200 (FIG. 2) and/or 300 (FIG. 3), as discussed below.

Additionally, BCM 24 may provide vehicle state information corresponding to the vehicle state or relating to certain vehicle components or systems. For example, the BCM may provide the device 30 with information indicating whether the vehicle's ignition is turned on, the gear the vehicle is presently in (i.e. gear state), and/or other information regarding the vehicle. The BCM 24 can obtain information from one or more other vehicle modules to obtain this information.

Wheel speed sensors 40 are sensors that are each coupled to a wheel and that can determine a rotational speed of the respective wheel. The rotational speeds from various wheel speed sensors can then be used to obtain a linear or transverse vehicle speed. Additionally, in some embodiments, the wheel speed sensors 40 can be used to determine acceleration of the vehicle. The wheel speed sensors 40 can include a tachometer that is coupled to a vehicle wheel and/or other rotating member. In some embodiments, wheel speed sensors 40 can be referred to as vehicle speed sensors (VS S) and can be a part of an anti-lock braking (ABS) system of the vehicle 12 and/or an electronic stability control program. As discussed more below, the electronic stability control program can be embodied in a computer application or program that can be stored on a non-transitory, computer-readable memory (such as that which is included in BCM 24 or memory 38). The electronic stability control program can be executed using a processor of BCM 24 (or processor 36 of the wireless communications device 30) and can use various sensor readings or data from a variety of vehicle sensors including wheel speed readings or sensor data from wheel speed sensor 40, steering wheel angle readings or sensor data from steering wheel angle sensor 42, yaw rate readings or sensor data from yaw rate sensor 44, throttle position readings or sensor data from throttle position sensor 46, and camera data from cameras 48.

Steering wheel angle sensor (or steering angle sensor) 42 is a sensor that is coupled to a steering wheel of vehicle 12 or a component of the steering wheel, including any of those that are a part of the steering column. The steering wheel angle sensor 42 can detect the angle that a steering wheel is rotated, which can correspond to the angle of one or more vehicle wheels with respect to a longitudinal axis of vehicle 12 that runs from the back to the front. Sensor data and/or readings from the steering wheel angle sensor 42 can be used in the electronic stability control program that can be executed on a processor of BCM 24 or processor 36.

Yaw rate sensor 44 obtains vehicle angular velocity information with respect to a vertical axis of the vehicle. The yaw rate sensor 44 can include gyroscopic mechanisms that can determine the yaw rate and/or the slip angle. Various types of yaw rate sensors can be used, including micromechanical yaw rate sensors and piezoelectric yaw rate sensors. The yaw rate sensor 42 can obtain various sensor data or readings (such as yaw rate readings and/or slip angle readings) and, then, this information can be communicated to BCM 24 (or other VSM) and used as a part of the electronic stability control program.

Throttle position sensor (TPS) 46 can be used to determine a position of a throttle device of vehicle 12. For example, the throttle position sensor 46 can be coupled to an electronic throttle body or system that is controlled by an actuator (such as a gas pedal) via a throttle actuation controller. TPS 46 can measure throttle position in a variety of ways, including through using a pin that rotates according to the throttle position (e.g., the output of the throttle actuation controller) and that reads a voltage through the pin. The voltage through the pin can vary due to the pin's position, which varies the amount of resistance of the circuit and, thus, the voltage. This voltage data (or other data derived therefrom) can be sent to BCM 24, which can use such readings as a part of the electronic stability control program, as well as various other programs or applications.

Cameras 48 can be used to capture photographs, videos, and/or other information pertaining to light. Cameras 48 can be an electronic digital camera that is powered through use of a vehicle battery. Cameras 48 may include a memory device and a processing device to store and/or process data that it captures or otherwise obtains. The data obtained by cameras 48 may be sent to another vehicle system module (VSM) such as wireless communications device 30 and/or BCM 24. Cameras 48 may be of any suitable camera type (e.g., charge coupled device (CCD), complementary metal oxide semiconductor (CMOS)) and may have any suitable lens known in the art. Some non-limiting examples of potential embodiments or features that may be used with cameras 48 include: infrared LEDs for night vision; wide angle or fish eye lenses; surface mount, flush mount, license mount, or side mount cameras; stereoscopic arrangements with multiple cameras; cameras integrated into tail lights, brake lights, or other components at the rear end of the vehicle; and wired or wireless cameras, to cite a few possibilities.

Wireless communications device 30 is capable of communicating data via short-range wireless communications (SRWC) and/or via cellular network communications through use of a cellular chipset 34, as depicted in the illustrated embodiment. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), body control module (BCM) 24, an infotainment module, a head unit, and/or a gateway module. In some embodiments, the device 30 can be implemented as an OEM-installed (embedded) or aftermarket device that is installed in the vehicle. In many embodiments, the wireless communications device 30 is a telematics unit (or telematics control unit) that is capable of carrying out cellular communications using one or more cellular carrier systems 70. The telematics unit can be integrated with the GNSS receiver 22 so that, for example, the GNSS receiver 22 and the wireless communications device (or telematics unit) 30 are directly connected to one another as opposed to being connected via communications bus 28.

Additionally, the wireless communications device 30 can be incorporated with or at least connected to a navigation system that includes geographical map information including geographical roadway map information. The navigation system can be communicatively coupled to the GNSS receiver 22 (either directly or via communications bus 28) and can include an on-board geographical map database that stores such geographical map information. This geographical map information can be provisioned in the vehicle when purchased or initialized after manufacture, or may be downloaded via a remote connection to a geographical map database/server, such as computer 78 and/or remote facility 80 (including servers 82 and databases 84). The on-board geographical map database can store geographical map information corresponding to a location or region of the vehicle so as to not include a large amount of data, much of which will most likely never be used for a given vehicle. Moreover, as the vehicle enters different locations or regions, the vehicle can inform the vehicle backend services facility 80 of the vehicle's location (e.g., obtained via use of GNSS receiver 22) and, in response to receiving the vehicle's new location, the servers 82 can query databases 84 for the corresponding geographical map information, such as elevation information, which can then be sent to the vehicle 12.

In some embodiments, wireless communications device 30 can be configured to communicate wirelessly according to one or more short-range wireless communications (SRWC) such as any of the Wi-Fi™, WiMAX™, Wi-Fi Direct™, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device. Additionally, in some embodiments, the wireless communications device may contain a cellular chipset 34 thereby allowing the device to communicate via one or more cellular protocols, such as those used by cellular carrier system 70.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may be a temporary powered memory or any non-transitory computer-readable medium; these include different types of RAM (random access memory) and ROM (read only memory) that stores some or all of the software needed to carry out the various external device functions discussed herein. Similar components to those previously described (processor 36 and/or memory 38, as well as SRWC circuit 32 and cellular chipset 34) can be included in body control module 24 and/or various other VSMs that typically include such processing/storing capabilities.

Vehicle electronics 20 also includes a number of vehicle user interfaces that provide vehicle occupants with a means of providing and/or receiving information, including pushbutton(s) 52, audio system 54, microphone 56, and visual display 58. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 28 and an entertainment bus (not shown) and can provide AM, FM and satellite radio, CD, DVD and other multimedia functionality. This functionality can be provided in conjunction with or independent of an infotainment module. Microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display and can be used to provide a multitude of input and output functions. Display 58 can be a touch screen on the instrument panel, a heads-up display reflected off of the windshield, or a projector that can project graphics for viewing by a vehicle occupant. Any one or more of these vehicle-user interfaces that can receive input from a user can be used to receive a driver override request, which is a request to cease operating the one or more VSMs as a part of the immersive media experience. Various other vehicle user interfaces can also be utilized, as the interfaces of FIG. 1 are only an example of one particular implementation.

With reference to FIG. 2, there is shown a method 200 of providing elevation correction information to a vehicle. Method 200 can be carried out by one or more computer programs that are stored on a non-transitory, computer-readable medium, and wherein one or more electronic servers (e.g., servers 82) located at the remote server facility are configured to execute the one or more computer programs thereby implementing the method 200. Generally, method 200 can include the steps of maintaining a map matching software system at a remote server facility, receiving an elevation correction request from the vehicle, extracting elevation information from the geographical maps based at least in part on the current vehicle location information, and sending the extracted elevation information to the vehicle. However, various other embodiments exist, as will be apparent from the discussion below in light of the discussion of system 10 provided above.

Method 200 begins with step 210, wherein a geographical map database is maintained. The geographical map database can store geographical map information corresponding to one or more states, countries, or other regions or territories. The geographical map information can include geographical coordinates of the surface of earth, including latitudinal coordinates, longitudinal coordinates, and elevation coordinates (or other elevation data), as well as various topographical information. The geographical map data can include other information such as vehicular roadway information (i.e., geographical roadway map data), which includes data representing roadways among the geographical regions, and/or vehicular airway information (i.e., airway map data), which includes data representing airways among the geographical regions. The geographical roadway map data can include various additional information, such as roadway dimensions, roadway attributes (e.g., speed limit, permitted direction of travel, lane information, traffic signal information), roadway conditions (e.g., present or estimated traffic conditions, predicted and/or observed weather conditions among the roadway), and various other information. This geographical map data can be provided to the vehicle periodically and, when doing so, the provided geographical map data can be refined to reflect information concerning an area surrounding or local to the vehicle, such as a metropolitan area of a large city in which the vehicle is located or nearby.

In some embodiments, the geographical map database can be constructed from geographical map information obtained from third-party geographical map providers. Additionally, at least in one embodiment, information contained within the geographical map database can be updated or altered by map matching software that is executed by one or more servers 82 of the remote server facility 80. The map matching software can also use geographical and/or sensor information obtained by the vehicle 12 (e.g., via GNSS receiver 22 and/or sensors 40-48) to correct, update, or alter information stored in the geographical map database. For example, roadways may be altered (e.g., a lane may be added or removed, a traffic circle may be used to replace an electronic traffic signal) and, thus, geographical and/or sensor information obtained from the vehicle can be used to adjust or update the geographical roadway map data that is kept in the geographical map databases 84. The method 200 continues to step 220.

In step 220, an elevation correction request from the vehicle is received. The elevation correction request can include current vehicle location information, such as geographical coordinates or other GNSS information that is obtained from the GNSS receiver 22. Other GNSS information can include vehicle speed or velocity, for example. In other embodiments, the vehicle can provide other location information that can be used to identify the vehicle's location, including points of interest or mailing addresses. In a particular embodiment, the current vehicle location information includes geographical information comprising a latitudinal coordinate of the vehicle, a longitudinal coordinate of the vehicle, and heading information of the vehicle, any or all of which may be obtained or derived from the GNSS receiver 22. And, additionally or alternatively, the vehicle location information can include elevation information obtained from the GNSS receiver 22. In some embodiments, the elevation correction request can include other vehicle sensor information, such as that information which is obtained from sensors 40-48, including wheel speed (or vehicle speed), yaw rate or slip angle, steering angle, throttle position, and/or observed roadway information from camera 48.

In one embodiment, the elevation correction request can be sent via cellular carrier system 70 and/or land network 76 to the remote server facility 80. The elevation correction request can be received at a server 82 and then stored in memory, such as in a vehicle transactional database that stores information concerning the operations of a plurality of vehicles. An elevation correction request acknowledgement message can be sent to the vehicle to notify the vehicle that the request was received and/or to query the vehicle for more information, such as for other GNSS information. The method 200 continues to step 230.

In step 230, elevation information is extracted from the geographical maps based at least in part on the current vehicle location information. Once the remote server facility 80 receives an elevation correction request from the vehicle, the remote server facility 80 can then query the database 84 for elevation data corresponding to the current vehicle location information (e.g., based on the vehicle's GNSS coordinates and/or any other suitable geographical information). For example, the lookup of elevation date from the database 84 may be based on GPS latitudinal and longitudinal coordinates of the vehicle as determined by the GNSS receiver 22. Elevation and other geographical map information (including geographical roadway map data) can be obtained for an area around the vehicle, including an area along a pathway, such as a roadway on which the vehicle is traveling. The elevation correction request can include heading information so that the remote facility 80 can determine a direction the vehicle is heading in along the roadway thereby allowing the vehicle to provide elevation and/or other geographical information of the area in the pathway of the vehicle. And, based on vehicle speed or other information contained in the elevation correction request, the remote facility 80 can determine the region, including the size and location (e.g., such as a bounding polygon defined by a plurality of coordinates), for which to query the database. This region can correspond to an area in which the vehicle is heading, such as an area down the road from the vehicle.

In some embodiments, the GNSS information (including coordinates, elevation information, and/or heading information) can be used in conjunction with geographical roadway map data to resolve a more accurate geographical location, including more accurate elevation information. For example, when GNSS reception is poor, the accuracy of the geographical coordinates may be reduced. However, the remote facility (and/or vehicle) can use geographical roadway map data to adjust the position of the vehicle; for example, if the coordinates (as determined by the GNSS receiver 22) correspond to an off-road area that is near a roadway and the heading information seems to track (or correspond to) the nearby roadway, the remote facility 80 may determine or predict that the vehicle is actually on the roadway and, thereafter, the facility 80 can use adjusted geographical coordinates as an input into the geographical map database so as to obtain elevation information corresponding to the adjusted vehicle location. The method 200 continues to step 240.

In step 240, the extracted elevation information is sent to the vehicle. In many embodiments, the extracted elevation information includes elevation information concerning an area at or near the vehicle or along a pathway of the vehicle, such as a roadway on which the vehicle is traveling. The extracted elevation information can be sent via land network 76 and/or cellular carrier system 70 and, in at least one embodiment, this information can be sent using the same connection and/or session as that which was used to receive the elevation correction request from the vehicle. The elevation information can then be input into a navigation system of the vehicle, such as that which may be carried out using wireless communications device 30 and/or GNSS receiver 22 (or other VSM). The elevation information can be used to replace elevation information obtained by GNSS receiver 22 and/or to supplement the elevation information received. In other embodiments, other corrected and/or updated GNSS information can be received from the remote facility 80 and used for carrying out various vehicle operations. The method 200 then ends.

With reference to FIG. 3, there is shown a method 300 of providing elevation correction information to a vehicle. Method 300 can be carried out by vehicle electronics 20 and, in some embodiments, can be carried out by wireless communications device 30, BCM 24, and/or GNSS receiver 22. Method 300 generally includes the steps of determining to send an elevation correction request to a remote server facility, sending the elevation correction request to the remote server facility, receiving an elevation correction response from the remote server facility, and then using the elevation information (or elevation correction information) received as a part of the response to carry out various vehicle functionality. Many steps of method 300 correspond to steps of method 200 (FIG. 2) and, as those skilled in the art will appreciate, the discussion and various embodiments mentioned with respect to method 200 can be incorporated into the method 300 and vice versa.

Method 300 begins with step 310, wherein it is determined whether to send an elevation correction request to the remote server. In some embodiments, an elevation correction request may be generated and sent to the remote server facility 80 periodically and according to a set time interval and/or distance interval. For example, the vehicle can generate and send an elevation correction request every 30 seconds or every 1 mile travelled by the vehicle. Additionally, in some embodiments, the periodicity of the elevation correction requests can change based on vehicle speed, heading, change of direction or route, and/or various other factors. For example, when the vehicle is traveling along a highway or interstate, an elevation correction request can be sent every 30 seconds; however, when the vehicle moves to an exit lane or exit ramp, an elevation correction request may be immediately generated and sent to the remote facility so that information corresponding to the area off of the highway or interstate exit may readily be available upon the vehicle entering that location.

In some embodiments, an elevation correction request may be generated and sent to the remote server facility 80 upon the occurrence of a triggering event associated with reduced geographical accuracy of geographical coordinates, such as those that are obtained using GNSS receiver 22. For example, the vehicle may recognize when GNSS reception is poor and/or when the accuracy of the GNSS information as obtained via the GNSS receiver 22 is reduced, such as by determining that GNSS signals were only received from a small number of GNSS satellites. Other triggers can include areas where roadways overlap each other, such as in metropolitan areas that include stacked roadway systems (e.g., a highway over local roadways). And, furthermore, the vehicle can use geographical roadway map information to determine and/or anticipate areas of poor GNSS reception and/or reduced GNSS information accuracy, such as through analyzing areas in front of the vehicle's trajectory (or path) along a roadway. For example, local geographical roadway map data at the vehicle may indicate that the vehicle is approaching a long tunnel and, based on this information, the vehicle can determine to generate and send an elevation correction request. In another example, the vehicle may keep track of areas with low GNSS reception or areas where GNSS information is usually inaccurate and, upon reaching or nearing these areas, the elevation correction request can be sent to the remote facility 80. In another embodiment, the vehicle can periodically send geographical information (e.g., geographical coordinates as determined by the GNSS receiver 22) to the remote server facility 80, which can then determine whether and/or when to send an elevation correction response to the vehicle using any or all of the various mechanisms discussed above (to the extent they are consistent with being carried out at the remote server facility 80). The method 300 continues to step 320.

In step 320, the elevation correction request is sent to the remote server facility when it is determined to send the elevation correction request. The elevation correction request can be generated once it is determined to send the elevation correction request and, at least in one embodiment, the request can be generated by wireless communications device 30. The wireless communications device 30 can receive GNSS information from the GNSS receiver 22 and may then compile some or all of this information into the elevation correction request. As those skilled in the art will appreciate, the elevation correction request (and any other messages discussed herein) can be sent using one or more packets according to the transmission protocol used by the communications device 30. The elevation correction request can be sent using cellular chipset 34 via cellular carrier system 70 and/or land network 76. The method 300 continues to step 330.

In step 330, the elevation correction response is received at the vehicle. The elevation correction response can include elevation information corresponding to an area at or near the vehicle or along a pathway of the vehicle, such as an area along a roadway that the vehicle is approaching. The elevation correction response can be received via cellular carrier system 70 and/or land network 76. And, in at least one embodiment, the elevation correction response can be received via the same connection or session as that which was used to send the elevation connection response (step 320). Once the elevation correction response is received, the method continues to step 340.

In step 340, the received elevation information is used by the vehicle for one or more vehicle operations. In one embodiment, the elevation information can be obtained (or extracted) from the elevation correction response (via use of processor 36) and then sent to one or more VSMs, such as BCM 24 and/or GNSS receiver 22. The elevation information can correspond to a height that is represented in feet or meters above sea level (i.e., with sea level being set to 0 feet or meters) or that corresponds to a different reference point. This elevation information (and other received information) can be sent to the GNSS receiver 22 and, thus, incorporated or used to adjust GNSS information as determined by the GNSS receiver 22 via reception of GNSS signals. And, at least in some embodiments, the elevation information can be sent to a navigation system of the vehicle and used for carrying out vehicle navigational services, which can be used for various autonomous and/or semi-autonomous vehicle functionality, as well as various other vehicle functionality. In a particular embodiment, the elevation information can be used with other GNSS information to calibrate a dead reckoning program or feature of the vehicle so that a more accurate, initial reference point can be used as a starting point (or adjustment point) for the dead reckoning program or feature. The method 300 then ends.

In one embodiment, the method 200, the method 300, or parts thereof can be implemented in a computer program (or “application”) embodied in a computer readable medium and including instructions usable by one or more processors of one or more computers of one or more systems. The computer program may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media (such as memory 38, memory in BCM 24, and/or memory of servers 82), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method(s).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method of providing elevation information to a vehicle, the method comprising:
maintaining a map matching software system at a remote server facility, wherein the remote software system includes a geographical map database storing geographical maps;
receiving an elevation correction request from the vehicle, wherein the elevation correction request includes current vehicle location information;
in response to receiving the elevation correction request from the vehicle, extracting elevation information from the geographical maps based at least in part on the current vehicle location information; and
after extracting the elevation information from the geographical maps, sending the extracted elevation information to the vehicle, wherein the extracted elevation information includes elevation information concerning an area at or near the vehicle or along a pathway of the vehicle.

2. The method of claim 1, wherein the maintaining step further comprises periodically aggregating map data from third-party map sources.

3. The method of claim 2, wherein the current vehicle location information comprises geographical information and wherein the method further comprising the step of incorporating the received geographical information into the geographical map database along with the aggregated map data from the third-party map sources.

4. The method of claim 1, wherein the vehicle is configured to generate and send the elevation correction request upon the occurrence of a triggering event associated with reduced geographical accuracy of geographical coordinates as determined onboard by the vehicle through reception of a plurality of global navigation satellite system (GNSS) signals from a constellation of GNSS satellites.

5. The method of claim 1, wherein the vehicle is configured to periodically send the elevation correction request to the remote server facility.

6. The method of claim 5, wherein the current vehicle location information includes a latitudinal coordinate of the vehicle, a longitudinal coordinate of the vehicle, and heading information of the vehicle.

7. The method of claim 1, further comprising the step of sending a geographical map update to the vehicle, wherein the geographical map update includes updated geographical map information of an area surrounding the vehicle and/or new geographical map information of an area surrounding the vehicle of which the vehicle does not presently include geographical map information.

8. The method of claim 1, wherein the method is embodied within one or more computer programs that are stored on a non-transitory computer-readable medium, and wherein the computer-readable medium comprises a part of one or more electronic servers that are located at the remote server facility and that are configured to execute the one or more computer programs, thereby implementing the method using the one or more servers.

9. The method of claim 1, wherein the elevation information includes elevation data of an area corresponding to the current vehicle location information.

10. The method of claim 9, wherein the extracting step further comprises using the current vehicle location information to query a geographical map database for the elevation information of the area corresponding to the current vehicle location information.

11. The method of claim 10, wherein the extracting step further comprises using the current vehicle location information in conjunction with geographical roadway map data to determine a location of the vehicle along a roadway and, thereafter, querying the geographical map database for the elevation information of the roadway at the location of the vehicle.

12. A method of providing elevation information to a vehicle, the method comprising:
receiving an elevation correction request from the vehicle, wherein the elevation correction request includes geographical information of the vehicle, and wherein the geographical information of the vehicle includes a latitudinal coordinate of the vehicle, a longitudinal coordinate of the vehicle, and heading information of the vehicle;
in response to receiving the elevation correction request from the vehicle, obtaining elevation information from a geographical map database that is located at a remote server facility, wherein the elevation information is obtained based at least in part on the geographical information of the vehicle; and
after obtaining the elevation information from the geographical map database, sending the obtained elevation information to the vehicle, wherein the obtained elevation information includes elevation information concerning an area in front of the vehicle and along a pathway of the vehicle.

13. The method of claim 12, wherein the elevation correction request includes heading information of the vehicle and wherein the heading information is used to determine the area in front of the vehicle and along the pathway of the vehicle.

14. The method of claim 12, wherein the obtaining step includes querying the geographical map database for geographical roadway map data and then using map matching software to determine a geographical coordinate location of the vehicle based on the geographical information of the vehicle as received in the elevation correction request and the geographical roadway map data.

15. The method of claim 14, wherein the map matching software is used to obtain the geographical coordinate location of the vehicle by mapping the geographical information of the vehicle to a roadway as indicated in the geographical roadway map data.

16. A method of providing elevation correction information to a vehicle, the method comprising:
determining to send an elevation correction request to a remote server facility;
when it is determined to send the elevation correction request to the remote server facility, sending the elevation correction request to the remote server facility, wherein the elevation correction request includes geographical information of the vehicle, and wherein the geographical information of the vehicle includes a latitudinal coordinate of the vehicle, a longitudinal coordinate of the vehicle, and heading information of the vehicle;
receiving an elevation correction response from the remote server facility, wherein the elevation information is based at least in part on the geographical information of the vehicle; and
carrying out one or more vehicle operations using one or more vehicle system modules (VSMs) of the vehicle using the elevation information.

17. The method of claim 16, wherein the geographical information of the vehicle is obtained using a global navigation satellite system (GNSS) receiver included in the vehicle.

18. The method of claim 17, wherein the determining step includes recognizing a triggering event associated with reduced geographical accuracy of geographical coordinates as determined onboard by the vehicle through reception of a plurality of global navigation satellite system (GNSS) signals from a constellation of GNSS satellites.

19. The method of claim 18, wherein the triggering event is recognized by determining that there are less than a predefined number of GNSS satellites of which GNSS signals are presently receivable by the GNSS receiver of the vehicle.

20. The method of claim 16, wherein the vehicle periodically sends the elevation correction request to the remote server facility and wherein the elevation correction response is received when the remote server facilities determines that any or all of the geographical information of the vehicle is inaccurate.
